(19) United States
(12) Patent Application Publication
(10) Pub. No.: US 2010/0151236 A1
(43) Pub. Date: Jun. 17, 2010

(54) SURFACE TREATMENT FOR POLYMERIC PART ADHESION

(75) Inventors: Joseph Walter Holubka, Livonia, MI (US); Ann Marie Straccia, Southgate, MI (US); Larry P. Haack, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/332,772

(22) Filed: Dec. 11, 2008

(51) Int. Cl. B32B 33/00; B32B 38/00

(52) U.S. Cl. 428/343; 156/273.3

(57) ABSTRACT

A surface treatment for polymeric part adhesion and a treated part is provided. In one aspect, a method for adhesively securing a part to a polymeric substrate is provided comprising providing an adhesive layer having a bonding surface having a first oxygen composition, a part having a bondable surface, and a polymeric substrate having a mating surface. Spray from an air plasma device is directed onto at least a portion of the bonding surface of the adhesive to provide a second oxygen composition on the bonding surface of the adhesive layer, with the second oxygen composition being greater than the first oxygen composition. The adhesive layer is secured between the bondable surface of the part and the mating surface of the polymeric substrate.

### BACKGROUND OF THE INVENTION

1. Field of the Invention

In at least one aspect, the present invention relates generally to adhesive bonding of polymeric parts.

2. Background Art

The manufacturing industry relies heavily upon attaching polymeric parts to one another to form plastic assemblies. It is desired that the adhesive bond between the parts last the useful life of the assembly. Significant warranty costs can occur as a result of premature adhesion loss.

Double sided adhesives are commonly used to attach a polymeric part to a polymeric, or coated non-polymeric, substrate. Typically, one side of the adhesive is applied to the polymeric part by the part supplier as the opposing side is covered with peel paper. The peel paper is removed from the adhesive during further assembly or rather when the substrate becomes available for subsequent bonding.

The mating or bonding surfaces must have suitable surface groups for adhesion. In order to achieve suitable surface groups and sufficient bond strength in adhesives, surface-active processing aids, also referred to as additives and coupling agents, are typically included in the chemical makeup of the adhesive. Although these additives and coupling agents help facilitate a strong bond between adjoining surfaces, they can be environmentally toxic and/or expensive.

Accordingly, a need exists for improving adhesion of polymeric parts which addresses at least one of the above issues without unduly affecting adhesive performance and the like.

### SUMMARY OF THE INVENTION

Under the invention, a method for bonding a polymeric part to a polymeric substrate is provided. In at least one embodiment, the method comprises providing an adhesive layer having a bonding surface having a first oxygen composition, a part having a bondable surface, and a polymeric substrate having a mating surface. Spray from an air plasma device is directed onto at least a portion of the bonding surface of the adhesive to provide a second oxygen composition on the bonding surface of the adhesive layer, with the second oxygen composition being greater than the first oxygen composition. The adhesive layer is secured between the bondable surface of the part and the mating surface of the polymeric substrate.

In at least one embodiment, the adhesive layer is located on the bondable surface prior to providing the second oxygen composition on the bonding surface of the adhesive layer.

In yet another embodiment, the step of securing the adhesive layer between the bondable surface of the part and the mating surface of the polymeric substrate comprises applying pressure to secure the adhesive layer to the polymeric substrate.

In still yet another embodiment, the adhesive layer is secured to the bondable surface of the part after providing the second oxygen composition on the bonding surface of the adhesive layer.

In at least one embodiment, the second oxygen composition is 1-50 atomic percent greater, as measured by X-ray photoelectron spectroscopy, than the first oxygen composition, while in yet another embodiment, the second oxygen composition is 5-30 atomic percent greater than the first oxygen composition.

In at least some embodiments, the first oxygen composition is less than 20 atomic percent and the second oxygen composition is greater than 21 atomic percent, as measured by X-ray photoelectron spectroscopy.

In still yet another embodiment, the part is polymeric and the method further comprises directing spray from an air plasma device onto the bondable surface of the polymeric part and disposing the adhesive layer on the bondable surface of the polymeric part. In these embodiments, the bondable surface has a third oxygen composition prior to directing spray from an air plasma device onto the bondable surface and a fourth oxygen composition after directing spray from an air plasma device onto the bondable surface, with the third oxygen composition being less than 20 atomic percent and the fourth oxygen composition being at least 21 atomic percent, as measured by X-ray photoelectron spectroscopy.

In yet another embodiment, a method for securing a polymeric part to a polymeric substrate. In at least one embodiment, the method comprises providing a polymeric part having an adhesive layer having a first oxygen composition, and a polymeric substrate having a mating surface. The adhesive layer is oxidized by directing spray from an air plasma device onto the adhesive layer to provide the adhesive layer with a second oxygen composition, with the second oxygen composition being 5-30 atomic percent greater, as measured by X-ray photoelectron spectroscopy, than the first oxygen composition. The adhesive layer is cohesively secured to the mating surface of the polymeric substrate.

In another aspect, a readily attachable polymeric part assembly is provided. In at least one embodiment, the polymeric part assembly comprises a polymeric part having a bondable surface, and an adhesive layer having a first side attached to the bondable surface of the polymeric part and an oxidized second side for subsequent attachment to the polymeric body, wherein the oxidized second side of the adhesive layer has an oxygen composition 5-30 atomic percent greater, as measured by X-ray photoelectron spectroscopy, than the oxygen composition of the remainder of the adhesive layer.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a schematic side view of a vehicle application illustrating a door assembly having a polymeric body side molding adhered to a coated vehicle body door panel in accordance with one embodiment of the present invention;

FIG. 2 is a schematic cross sectional view of the door assembly shown in FIG. 1 taken along line 2-2;

FIGS. 3A-3D are schematic illustrations of an exemplary embodiment of a process employed in adhesively bonding a polymeric part to a substrate;

FIG. 4 is a schematic side view of treating the adhesive to form an upper layer along the adhesive having a modified surface chemistry;

FIG. 5 is a schematic side view illustrating treating the substrate in preparation for subsequent bonding; and

FIG. 6 is a schematic side view illustrating oxidizing the polymeric part prior to bonding.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various alternative forms. The figures are not necessarily to scale and some features may be exaggerated or minimized to show details of particular components. Therefore specific details disclosed herein are not to be interpreted as limiting, but merely as a representative basis for the claims and/or a representative basis for teaching one skilled in the art to variously employ the present invention.

Moreover, except where otherwise expressly indicated, all numerical quantities in this description and in the claims indicating amount of materials or conditions of reactions and/or use are to be understood as modified by the word “about” in describing the broader scope of this invention. Practice within the numerical limits stated is generally preferred. Also, unless expressly stated to the contrary, the description of a group or class of materials as suitable or preferred for a given purpose in connection with the invention implies that mixtures of any two or more members of the group or class may be equally suitable or preferred.

The present invention generally relates to increasing the adhesion between adjacent components, such as between a polymeric part and a substrate. In at least one embodiment, the adhesion between adjacent components is provided in large part by an adhesive layer. In at least one embodiment, adhesion between the polymeric part and the substrate is increased by providing at least one component, such as an adhesive layer, having a relatively high surface number (i.e., composition) of surface functional groups containing oxygen. In another embodiment, the adhesion between the polymeric part and the substrate is increased by increasing the number of surface functional groups containing oxygen or oxygen composition of the adhesive layer, and in some embodiments also of the substrate and/or plastic part. The surface composition may, in at least one instance, be quantified by the number or composition of hydroxyl and/or carboxyl groups in the surface of the adhesive layer, and optionally the substrate and/or plastic part. By surface, it is meant the top atomic layer, or layers, of the object being treated. These surface functional groups can serve as linkages for chemical bonding between adjacent layers.

In at least one embodiment, increasing the number/composition of surface functional groups containing oxygen, of the adhesive layer, comprises oxidizing at least a surface portion of the adhesive layer and optionally one or more of the plastic substrate or part. In at least one specific embodiment, oxidation can take place by exposing the adhesive layer and optionally one or more of the other components to a plasma spray from an Atmospheric Pressure Air Plasma (APAP) device.

Surface chemistries of adhesives typically comprise an assortment of carbon, nitrogen, silicon, and oxygen dispersed thereabout. In accordance with an embodiment of the present invention, oxidizing at least a portion of the adhesive having a first oxygen composition increases the relative amount of oxygen atoms relating to carbon atoms and/or the atomic percent of oxygen in the treated surface layers.

This increase provides more chemical groups to the surface to wet and bond to an adjacent surface, and thus forms a second oxygen composition on the surface of the adhesive layer having relatively higher oxygen composition and ability to cross-link and form chemical bonds with a corresponding mating surface.

In at least one embodiment, surface chemistry is measured as a portion of the adhesive layer rather than as the entire bulk of the adhesive layer. The surface chemistry is measured at the upper surface of the adhesive layer, which in at least one embodiment is the upper atomic layer or layers of the adhesive layer. The remainder of the adhesive layer is typically substantially untreated. The upper surface of the adhesive layer will have a second surface chemistry having a higher oxygen composition than the first surface chemistry.

In at least one embodiment, the first surface chemistry of the adhesive has an oxygen composition of less than 20 atomic percent and the second surface chemistry has an oxygen composition of at least 21 atomic percent, as measured by X-ray photoelectron spectroscopy.

In at least another embodiment, the second surface chemistry of the adhesive has a second oxygen composition of 23 to 50 atomic percent, in other embodiments of 24 to 40 atomic percent, and in yet another embodiment of 25 to 32 atomic percent, as measured by X-ray photoelectron spectroscopy.

In at least another embodiment, the first surface chemistry of the adhesive has a first oxygen composition of 7 to 20 atomic percent, in other embodiments of 10 to 19 atomic percent, and in yet another embodiment of 12 to 18 atomic percent, as measured by X-ray photoelectron spectroscopy.

In at least one embodiment, the second surface chemistry of the adhesive has an oxygen composition of 1 to 50 atomic percent, in other embodiments of 5 to 30 atomic percent, and in yet another embodiment of 10 to 20 atomic percent, more relative to the first surface chemistry, as measured by X-ray photoelectron spectroscopy.

In still yet another embodiment, the oxidized adhesive is substantially free of coupling agents and has a bond strength at least equivalent to or greater than a non-oxidized adhesive having coupling agents, by virtue of the potential for increased chemical bonding.

As discussed above, the plastic part and/or substrate can be oxidized in addition to oxidizing the adhesive. In these instances, the first surface chemistry of the plastic part and/or substrate has an oxygen composition of less than 20 atomic percent and the second surface chemistry has an oxygen composition of at least 21 atomic percent, as measured by X-ray photoelectron spectroscopy.

In at least another embodiment, the second surface chemistry of the plastic part and/or substrate has an oxygen composition of 1 to 50 atomic percent, in other embodiments of 5 to 30 atomic percent, and in yet another embodiment of 10 to 20 atomic percent, more relative to the first surface chemistry, as measured by X-ray photoelectron spectroscopy.

In at least another embodiment, the second surface chemistry of the part and/or plastic substrate has a second oxygen composition of 21 to 50 atomic percent, in other embodiments of 23 to 40 atomic percent, and in yet another embodiment of 24 to 32 atomic percent, as measured by X-ray photoelectron spectroscopy.

In at least another embodiment, the first surface chemistry of the part and/or plastic substrate has a first oxygen composition of 5 to 20 atomic percent, in other embodiments of 10 to 19 atomic percent, and in yet another embodiment of 13 to 18 atomic percent, as measured by X-ray photoelectron spectroscopy.

As set forth above, any one or combination of the adhesive and the plastic part, and/or substrate (including the polymeric coating) can be oxidized. For clarity the remainder of the specification will focus on oxidation of the adhesive, however, it should be understood that the oxidation description can apply equally well to the plastic part and substrate, including the polymeric coating.

Various oxidizing treatments exist for increasing the oxygen composition of the adhesive from the first oxygen composition to the second oxygen composition. These oxidizing treatments include, and are not limited to, ultraviolet (UV) radiation, ozone, corona discharge, flame, combustion sources, vacuum plasma, and atmospheric pressure air plasma (APAP).

Although no known adhesive is incapable of being oxidized, capable adhesives may comprise, and are not limited to, moisture-cured urethane adhesives, moisture-cured silicone adhesives, 1-part and 2-part urethane adhesives, silicone adhesives, epoxy adhesives, butyl adhesives, acrylic adhesives, cyanic-acrylic adhesives, and hot-melt thermoplastic adhesives.

In one embodiment, an APAP device oxidizes the bondable surface of the adhesive as it passes over the adhesive. The APAP device uses pressurized air as a reactant gas and generates spray at a high velocity, also referred to in industry as a flume, plasma jet, air plasma stream, and the like. As will be further appreciated below, this spray may be directed through an air plasma nozzle and onto a portion of the adhesive. Directing this spray onto a portion of the adhesive can also cleanse at least that portion of contaminants and can operate to increase the oxygen composition such that the portion of the adhesive has elevated levels of oxygen. As aforementioned, oxidizing the adhesive increases the ability of the adhesive to cross-link with mating surfaces and form chemical bonds.

It may be helpful to understand approximate exemplary operating conditions at which a typical APAP device may function. It is common for typical APAP devices to proceed along a path at a velocity of up to 1000 mm/sec. APAP devices may be placed up to 25 mm from a receiving surface. The spray may be emitted in a number of spray patterns and arrangements, two of which may be cylindrical or cone shaped. The cone shaped spray may be angled between 0 and 30 degrees relative to the spray emission. These spray patterns may be roughly 6 to 200 mm wide per treatment pass. The spray may be rotated at speeds of up to 3,000 revolutions per minute or added in series with additional APAP devices for enhanced treatment or larger application areas. Additionally, it should be appreciated that the spray width may be a function of nozzle spray angle and the height offset between the receiving surface and the lower end of the APAP device.

In at least one embodiment, a portion of the receiving area can be masked such that the masked area does not receive the spray and the unmasked area does receive the spray.

The APAP process is considered a cold plasma because it, unlike flame treatment, does not use additional heat to ionize, or rather oxidize a surface. Incidental warming of the surface may occur, but the relatively low temperature of the APAP treatment provides compatibility with components that might otherwise be susceptible to heat damage from other treatments.

In at least another embodiment, additional gases can be supplied to augment the gases ionized or discharged from the APAP device. Non-limiting examples of such gases include ammonia, carbon dioxide, oxygen, nitrogen, helium, argon, other noble gases, and combinations thereof. Additionally, water vapor may be inputted to the APAP device. This embodiment may be particularly advantageous for unique applications such as, for example, urethane coatings, materials having free isocyanate groups, Xenoy, polybenzimidazoles, polysulfones, polyether-modes, and aromatic polyurea.

As one skilled in the art should recognize, there is a broad spectrum of industries which can benefit from a robust adhesive, particularly with little or no relevance on coupling agents. The adhesion of polymeric parts such as, for example, moldings, claddings, decals, and paint stripes are common in most industries regardless of the end product. Polymeric parts are used on boats, toys, binders, houses, and cellular phones to list a few. Many times the polymeric part and/or substrate are plastic and may be made from acrylonitrile butadiene styrene (ABS), conductive polymers, polycarbonates (PC), polyethylene (PE), polyester, thermoplastic elastomers (TPEs), thermoplastic polyolefins (TPOs), and polypropylene. In some instances, the substrate can be non-polymeric, but coated with a polymeric coating, such as a paint system.

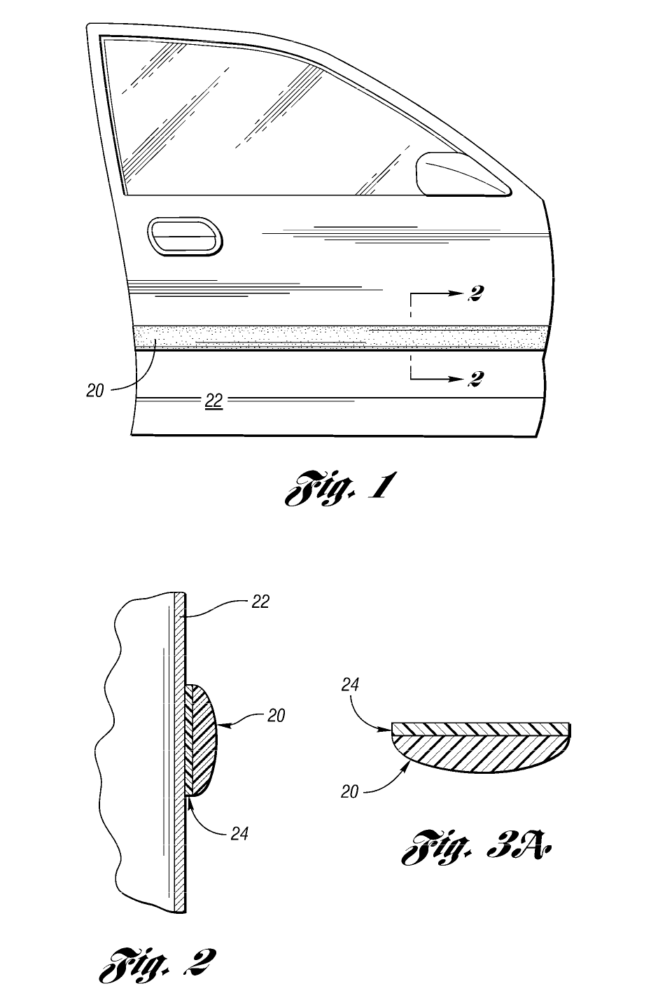

FIG. 1 shows a vehicle embodiment wherein a body side molding 20, exemplifying a part, preferably made of a polymeric material, has been adhered to a coated vehicle body panel 22, exemplifying a polymeric substrate. The coated vehicle body panel 22 may be made of a metallic or polymeric body substrate which has been coated with a number of materials including, and not limited to, polymeric paint and/or clearcoat.

Referring now to FIG. 2, the cross sectional view illustrates an adhesive layer 24 attaching the body side molding 20 to the coated vehicle body panel 22. The adhesive layer 24, having at least one oxygen enriched surface, is chemically bonded between the body side molding 20 and the coated vehicle body panel 22.

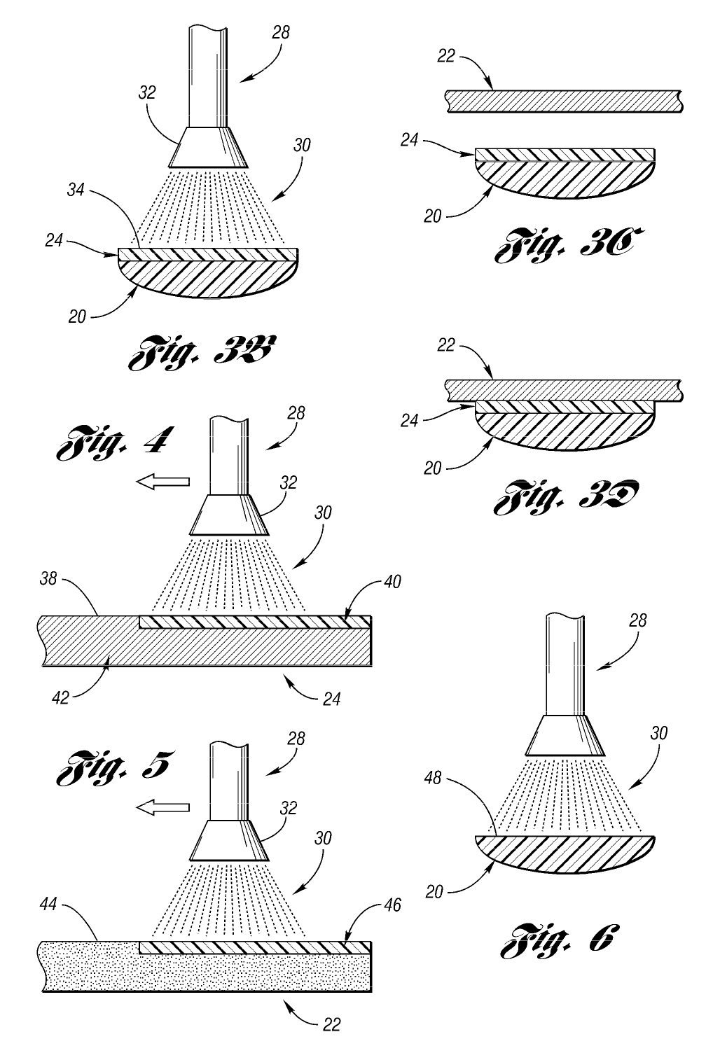

Referring to FIGS. 3A-3D, one exemplary embodiment of oxidizing the adhesive layer 24 is shown. A polymeric part 20, such as a body molding, having the adhesive layer 24 attached is provided. An APAP device 28 directs spray 30 through an APAP nozzle 32 onto an upper surface portion 34 of the adhesive layer 24. This action modifies the surface chemistry of the upper surface portion, i.e., top atomic layer, 34 of the adhesive layer 24 from the first surface composition to the second surface composition having a higher atomic percentage of oxygen. Now that the upper surface portion 34 of the adhesive layer 24 has been activated for subsequent bonding, the polymeric substrate 22 is introduced and attached forming a plurality of chemical bonds between the adjoining surfaces. Again, it should be understood that either in addition to oxidizing the adhesive layer 24, the substrate 22 and/or polymeric part 20 can also be oxidized or activated for improving bonding.

FIG. 4 illustrates in more detail an exemplary process of modifying a first surface chemistry or composition of an adhesive layer 24 to form a second surface chemistry or composition. Referring to FIG. 4, spray 30 from the APAP device 28 is directed at the adhesive layer 24 to modify a first surface chemistry 38 of the adhesive layer 24 having the first oxygen composition. This forms a second surface chemistry of the adhesive 24, shown by 40, which has the second oxygen composition with a higher oxygen composition relative to the first surface chemistry. The chemistry of a lower portion of the adhesive 24, shown generally by 42, remains substantially unchanged.

Weak boundary or contaminant layers can prevent robust adhesion and should ideally be removed from components prior to attachment. In yet another embodiment, the APAP device 28 may direct spray 30 at the polymeric substrate 22 prior to attaching an adhesive layer, such as 24. As discussed above, this process helps to remove contaminants and expose more functional groups containing oxygen. As shown in FIG. 5, the polymeric substrate 22 may be a polymeric coating on a larger component such as a body portion of a vehicle (not shown for clarity). In addition to the previously mentioned materials, various paints and coatings may comprise the polymeric substrate 22 such as, for example, acrylic urethane, epoxy based paint, epoxy-acid paint, melamine cross-linked acrylic paint, isocyanate containing paint, etch resistant coatings based on carbamate chemistry, silane modified acrylic melemine based coatings, alkyds, polyesters, and the like.

As schematically shown in FIG. 5, the polymeric substrate 22 has a mating surface 44 to be treated by the APAP device 28. After directing spray 30 at the mating surface 44 of the polymeric substrate 22, functionalized polymeric layer 46 is available for ensuing bonding. The functionalized polymeric layer 46 has better adhesive properties and will more readily form chemical bonds with an adhesive.

In another vehicle embodiment, directing spray 30 from the APAP device 28 at the polymeric substrate 22 may reduce or even eliminate the need for cleansing columns to wipe the polymeric substrate 22 prior to attaching components.

As schematically shown in FIG. 6, in a further embodiment, the APAP device 28 may direct spray 30 onto a mating surface 48 of the polymeric part 20 prior to attaching an adhesive layer, such as 24. Referring now to FIG. 6, the mating surface 48 of the polymeric part 20 may undergo a cleansing similar to that described for the polymeric substrate 22.

In another embodiment, the adhesive layer 24 is a pressure sensitive adhesive and may be applied to the polymeric part 20 and/or the polymeric substrate 22 by applying pressure to the adhesive layer 24 or an appropriately accessible component. In yet another embodiment, both sides of the adhesive layer 24 can be treated. This can be done, for instance, by providing the adhesive layer 24 on a carrier (not shown), separate from the components 20 and 22.

Parts can be commonly exposed to considerable environmental dirt and contaminants in a manufacturing plant. Part suppliers may place peel paper, or any suitable release tape, along the adhesive to preserve qualities of its adhesive surface prior to shipping the part to the manufacturer. In an additional embodiment, peel paper may be applied to the adhesive after at least one of the surfaces of the adhesive has been oxidized. The peel paper may then be removed from the adhesive in the assembly plant, or whenever appropriate, leaving an oxygen enriched surface for attachment.

In yet another embodiment, a manufacturer may oxidize an adhesive directly within an assembly plant. For instance, a part supplier may ship a part having an adhesive layer covered with peel paper. The manufacturer may then remove the peel paper and oxidize the adhesive surface prior to further assembly.

A further embodiment involves a robot controlling the APAP device 28 and directing its spray 30 in a precise fashion. This embodiment may be advantageous for exact or fine applications.

Another embodiment exists wherein only the leading edges of the mating surfaces are treated. Leading edges of an adhesively attached assembly can be more particularly susceptible to adhesion failure. If cycle time and/or cost may be typical constraints in an operation, treating solely the corners of the adhesive and mating parts may prolong the lifetime of the assembly without unduly affecting time and/or cost.

Further vehicle embodiments exist wherein the polymeric part or substrate comprise, but are not limited to, painted TPO components, body panels, housings, body side moldings, roof ditch moldings, paint striping, tapes, labels, product badges, decals, body panels, bumper fascias, housings, painted vehicle body panels, painted plastic/composite parts, molded-in color plastic parts, film laminates, painted TPO parts, polypropylene parts, chrome plated parts, chrome parts, PC/ABS parts, vinyl parts, composite parts, vehicle frames, sunroof linings, mirrors, elastomeric trim strips, and componentry and electronic circuit boards underneath the hood.

An embodiment exists wherein at least the adhesive is treated. Another embodiment exists wherein at least one surface along the adhesive and any combination of other mating surfaces are treated.

The following non-limiting examples demonstrate certain aspects of certain embodiments of the present invention.

### EXAMPLE 1

Example 1 involves bonding a PSA-backed decal to an automotive clearcoat paint. This example compares a current PSA bonding process to a plasma treated PSA bonding process.

### Experimental

### X-Ray Photoelectron Spectroscopy Surface Analysis

Surface analyses are performed using x-ray photoelectron spectroscopy (XPS). A Kratos AXIS 165 XPS is used to determine the chemical states and measure elemental surface compositions. Photoelectrons are generated using a monochromatic A1 Kα (1486.6 eV) x-ray excitation source operated at 12 kV and 20 mA (240 W) and collected using hybrid mode magnification with the analyzer at a 20 eV pass energy for high resolution spectra, and 80 eV pass energy for survey spectra. Quantification of survey data is accomplished by means of routines based on Scofield photoionization cross-section values.

High Resolution C 1s core level spectra are acquired for speciation of carbon oxidation chemistry. The XPS C 1s core level spectrum is the photoelectron emission from the C 1s core level as a result of sample irradiation by A1 Kα x-rays. A least squares based fitting routine is used to peak fit the high resolution core level spectra. This routine is allowed to iterate freely on the peak positions, peak heights, and peak widths. Binding energies are referenced to the aliphatic C 1s line at 284.6 eV.

### Plasma Treatments

Plasma treatments to both the PSA (pressure-sensitive adhesive) and clearcoat paint surfaces are accomplished using an atmospheric pressure air plasma (APAP) system manufactured by Plasmatreat, North American, Inc. The system is equipped with a rotational RD-1004 head. A one-inch diameter nozzle rotating at 2000 rpm is employed to deliver the plasma at a distance of 8-10 mm and speeds of 10-18 m/min.

### Materials and Sample Preparation

The materials include automotive clearcoat panels, identified as Clearcoat 1, and decals with PSA release paper on the backside, identified as PSA 1.

Control Process. The surface of a Clearcoat 1 sample is prepared by subjecting it to an isopropyl alcohol wipe (IPA wipe). The release paper on the back of the decal is removed, exposing the PSA 1. The exposed PSA 1 is then immediately applied to the IPA wipe Clearcoat 1 sample.

Plasma Process. A Clearcoat 1 sample is plasma treated at a distance of 8 mm and a speed of 10 m/min. Prior to bonding, the release paper on the back of a decal is removed and the exposed adhesive is plasma treated at a distance of 8 mm and a speed of 10 m/min (PSA—plasma treatment 1). Immediately after treatment, the decal was applied to the plasma treated clearcoat panel.

90° Manual Peel Adhesion Testing. Decal tape is manually pulled away from the clearcoat panel with the pull force perpendicular to the clearcoat panel.

### Results

### 90° Manual Peel Adhesion

After 72 hours, the tape is pulled manually at 90 degrees from the substrate to create interfacially de-adhered surfaces. The control sample fails adhesively between the PSA and the clearcoat, with no residual adhesive remaining on the clearcoat surface. Whereas for the plasma treated system (i.e., the plasma treated adhesive secured to the plasma treated clearcoat panel), the failure occurs cohesively within the PSA with adhesive remaining on the clearcoated surface, revealing that the bonding strength between the PSA and the clearcoat was greater than the internal cohesive bond strength of the PSA.

### XPS Surface Analysis

Elemental Composition. Table 1 shows the comparison of surface chemistry between no treatment conditions and after plasma treatment at a distance of 8 mm and a speed of 10 m/min. For both plasma treated Clearcoat 1 and PSA 1, the results show a reduction in surface carbon and a concurrent increase in surface oxygen. A 9 atomic % increase in oxygen composition is measured for Clearcoat 1 and an 8 atomic % increase in oxygen is measured for PSA 1. Further chemical changes are detected for plasma treated PSA 1 by the presence of nitrogen on the surface.

XPS C 1s Core Level. Details of the incorporation of oxygen are shown in the XPS C 1s core level high resolution spectra in FIG. 1. Initial spectra of Clearcoat 1 and PSA 1 untreated surfaces are overlaid with the spectra of the corresponding plasma treated surfaces. Through standard curve fitting methods, peaks are observed at binding energies of 284.6 eV, 285.2 eV, 286.2 eV, 287.4 eV, 288.6 eV and 289.6 eV, identified as the following chemical states: (A) aliphatic, (B) beta shifted aliphatic, (C) alcohol/ether, (D) ketone/aldehyde, (E) carboxyl and (F) carbonate, respectively. The overlaid spectra illustrates the increase and/or addition of oxygen functionality associated with carbon after plasma treatment as compared to initial surfaces.

Specific peak fits and associated chemical states associated with the C 1s envelope are individually quantified in Table 2. For Clearcoat 1, approximately 70% of the overall added functionality from plasma treatment is added as carboxyl with the remainder added as alcohol/ether groups. For PSA 1, alcohol/ether groups account for 38% of the overall added functionality after plasma treatment, whereas carbonyl groups accounted for 33%. Also for PSA 1, additional functionality is added as ketone/aldehyde and carbonate groups.

TABLE 1
Pressure Sensitive Adhesive on Decal
XPS Analysis

Elemental
Composition-Atomic %

| Sample | C | O | N | Si |
|---|---|---|---|---|
| Clearcoat 1 | | | | |
| IPA Wipe | 69.3 | 19.0 | 8.2 | 3.4 |
| Plasma Treatment 1 | 60.0 | 28.2 | 8.0 | 3.8 |
| PSA 1 | | | | |
| No Treatment | 80.8 | 17.3 | — | 1.9 |
| Plasma Treatment 1 | 70.8 | 25.4 | 1.6 | 2.2 |

TABLE 2
XPS Core Level C 1s Peak Fitting Data

| | % of Peak Envelope | | | | | |
|---|---|---|---|---|---|---|
| Peak | | B | C | D | | |
| Chemical State | A | beta- | Alcohol/ | Ketone/ | E | F |
| Binding | Aliphatic | shifted | Ether | Aldehyde | Carboxyl | Carbonate |
| Energy (eV) | 284.6 | 285.2 | 286.2 | 287.4 | 288.6 | 289.6 |
| Clearcoat 1 | | | | | | |
| No | 55.7 | 4.5 | 18.0 | 14.0 | 7.8 | — |
| Treatment | | | | | | |
| Plasma | 50.5 | 4.7 | 19.5 | 14.1 | 11.3 | — |
| PSA 1 | | | | | | |
| No | 77.4 | 5.0 | 8.5 | — | 9.1 | — |
| Treatment | | | | | | |
| Plasma | 60.4 | 10.2 | 13.0 | 2.6 | 13.0 | 0.8 |

### EXAMPLE 2

Example 2 involves an evaluation of the effects of plasma treatments on bonding a double sided PSA foam carrier to automotive clearcoat paint. The foam is initially rolled with a single tape backing, which thus serves as a “release tape” for the PSA on both sides of the foam.

### Experimental

### X-Ray Photoelectron Spectroscopy Surface Analysis

XPS is performed using the parameters outlined in Example 1.

### Plasma Treatment Parameters

Plasma Treatment 1 (high exposure) is performed at a distance of 10 mm and a speed of 10 m/min. and Treatment 2 (low exposure) is performed at a distance of 10 mm and a speed of 18 m/min.

### Materials and Pre-Treatments

The automotive clearcoat panels and the PSA used in Example 2 are of different material composition to the materials used in Example 1. The designation Clearcoat 2 and PSA 2 refer to the system in Example 2. The pre-treatment conditions examined in this study for clearcoat include no pre-treatment, IPA wipe, plasma treatment 1 and 2. As for the PSA, the conditions are no pre-treatment and plasma treatment 1 and 2.

### Sample Preparation and Experimental Test Matrix (Refer to Table 3)

Clearcoat panels are cut 25 mm×75 mm in size. For clearcoat panels receiving a pre-treatment, each bonding surface of the lap shear is treated in the same manner. This is also true for the foam/PSA, where both sides of the foam with the PSA are treated. Additionally, when the foam/PSA is unrolled, only one side of the foam has release paper remaining. The foam/PSA is cut to 50 mm length. Total bond area is 645 mm².

Control Process. Controls are prepared by pre-treating Clearcoat 2 or PSA 2 according to the test matrix. The foam/PSA 2 is directly applied to one lap shear panel. Prior to bonding the second clearcoat panel, the release paper on the back of the foam/PSA 2 is removed, exposing the PSA. The second clearcoat lap shear panel is then placed on the exposed PSA. After the lap shear samples are prepared, pressure is applied to the bond area by placing a 7 kg weight for 3 sec. and the samples are then stored at ambient conditions for two weeks prior to dynamic shear testing.

Plasma Process. Plasma treated lap shear samples are prepared by pre-treating Clearcoat 2 or PSA 2 according to the test matrix. After the pre-treatment step the foam/PSA 2 is directly applied to one lap shear panel. Prior to bonding the second clearcoat panel, the release paper on the back of the foam/PSA 2 is removed, exposing the PSA. At this point, the PSA and/or clearcoat are pre-treated according to the test matrix. The second clearcoat lap shear panel is then placed on the exposed PSA. After lap shear samples are prepared, pressure is applied to the bond area by placing a 7 kg weight for 3 sec. and the samples are then stored at ambient conditions for two weeks prior to dynamic shear testing.

Dynamic Shear Testing. A tensile pull testing machine is used. Dynamic shear parameters include a jaw separation rate of 12 mm/min. and a 50 kg load cell.

### Results

### Dynamic Shear (Refer to Table 4)

Lap shear testing reveals an overall improvement of 29% in shear strength for all plasma treatment processes as compared to the controls [(S1 . . . S6)/(C1+C2)×100]. Overall, the top performing systems receives the highest level exposure, plasma treatment 1 (samples 1, 2 and 3). For instance, samples 1 and 2 perform 30.7% better when compared to the conventional process of IPA wiping [(S1+S2)/C2]. Sample 3 exhibits a 22% increase over the IPA wiped control [S3/C2×100]. For sample 1, both the clearcoat and PSA are plasma treated, whereas for sample 2, only the paint is plasma treated. For sample 3, only the PSA is plasma treated.

Additionally, both controls exhibit adhesive failure between the PSA and the clearcoat with no residual adhesive remaining on the clearcoat surface. For all plasma treated samples, the failure occurs cohesively within the foam/PSA with adhesive and foam remaining on the clearcoat surface. The modes of failure reveal that in the case of the plasma system, the shear adhesive strength of the bond between the PSA and the clearcoat is greater than that of the cohesive strength of the foam/PSA itself.

### XPS Surface Analysis

Elemental Composition. Table 5 shows the surface chemical comparison between no treatment conditions, IPA wiped and plasma treatment. For both plasma treated Clearcoat 2 and PSA 2, the results generally show a reduction in surface carbon and a concurrent increase in surface oxygen. More specifically, a 9 atomic % increase in oxygen composition is measured for Clearcoat 2 at plasma treatment 1 and 2. For PSA 2, a 9 atomic % and 11 atomic % increase in oxygen is detected for plasma treatment 1 and 2, respectively. Further chemical changes are detected for plasma treated PSA 2 by the presence of low levels of fluorine and sodium on the surface.

XPS C 1s Core Level. Through standard curve fitting methods, peaks are observed at binding energies of 284.6 eV, 285.2 eV, 286.2 eV, 287.4 eV, 288.6 eV and 289.6 eV, identified as the following chemical states: (A) aliphatic, (B) beta shifted aliphatic, (C) alcohol/ether, (D) ketone/aldehyde, (E) carboxyl and (F) carbonate, respectively. Specific peak fits and associated chemical states are individually quantified in Table 6. For Clearcoat 2, approximately 55% of the overall added functionality after plasma treatment was accounted for by ketone/aldehyde groups with the remaining 45% as carboxyl, carbonate and alcohol/ether functionality. For PSA 2, alcohol/ether groups account for approximately 45% of the overall added functionality after plasma treatment with additional functionality added in the form of ketone/aldehyde and carbonate.

TABLE 3
Test Matrix

| | No Pre- | | | Plasma | | Plasma | |
|---|---|---|---|---|---|---|---|
| | Treatment | | IPA Wipe | Treatment 1 | | Treatment 2 | |
| Samples | Paint | Tape | Paint | Paint | Tape | Paint | Tape |
| Control 1 | X | X | | | | | |
| Control 2 | | X | X | | | | |
| 1 | | | | X | X | | |
| 2 | | X | | X | | | |
| 3 | | | X | | X | | |
| 4 | | | | | | X | X |
| 5 | | X | | | | X | |
| 6 | | | X | | | | X |

TABLE 4
Shear Stress

| | Shear | |
|---|---|---|
| | Stress | |
| Samples | kPa | Failure Mode |
| Control 1 | 283 | Adhesive at the paint/PSA interface |
| Control 2 | 322 | Adhesive at the paint/PSA interface |
| 1 | 417 | Cohesive within the adhesive/foam |
| 2 | 425 | Cohesive within the adhesive/foam |
| 3 | 392 | Cohesive within the adhesive |
| 4 | 384 | Cohesive within the adhesive/foam |
| 5 | 358 | Cohesive within the adhesive |
| 6 | 365 | Cohesive within the adhesive |

TABLE 5
Pressure Sensitive Adhesive with Foam Carrier
XPS Analysis

| | Elemental Composition-Atomic % | | | | | | |
|---|---|---|---|---|---|---|---|
| Sample | C | O | N | F | Na | Si | S |
| Clearcoat 2 | | | | | | | |
| No Treatment | 76.3 | 19.6 | 4.0 | — | — | — | 0.18 |
| IPA Wiped | 77.1 | 16.8 | 5.7 | — | — | 0.16 | 0.24 |
| Plasma | 68.4 | 25.6 | 5.7 | — | — | — | 0.25 |
| Treatment 1 | | | | | | | |
| Plasma | 68.3 | 26.3 | 5.2 | — | — | — | 0.25 |
| Treatment 2 | | | | | | | |
| PSA 2 | | | | | | | |
| No Treatment | 83.6 | 16.4 | — | — | — | — | — |
| Plasma | 68.9 | 27.5 | 2.8 | 0.47 | 0.31 | — | — |
| Treatment 1 | | | | | | | |
| Plasma | 71.6 | 26.2 | 1.5 | 0.56 | 0.17 | — | — |
| Treatment 2 | | | | | | | |

TABLE 6
XPS Core Level C 1s Peak Fitting Data

| | % of Peak Envelope | | | | | |
|---|---|---|---|---|---|---|
| Peak | | B | C | D | | |
| Chemical State | A | beta- | Alcohol/ | Ketone/ | E | F |
| Binding | Aliphatic | shifted | Ether | Aldehyde | Carboxyl | Carbonate |
| Energy (eV) | 284.6 | 285.2 | 286.2 | 287.4 | 288.6 | 289.6 |
| Clearcoat 2 | | | | | | |
| No | 54.3 | 12.5 | 16.1 | 4.8 | 10.4 | 1.8 |
| Treatment | | | | | | |
| IPA Wiped | 56.2 | 12.5 | 17.3 | 4.7 | 8.4 | 1 |
| Plasma 1 | 43.6 | 11.8 | 17.4 | 11.1 | 12.4 | 3.6 |
| Plasma 2 | 44.1 | 11.8 | 17.4 | 10.5 | 12.6 | 3.6 |
| PSA 2 | | | | | | |
| No | 69.7 | 10.7 | 9.5 | — | 10.1 | — |
| Treatment | | | | | | |
| Plasma 1 | 49.9 | 10.1 | 18.7 | 5.7 | 12.6 | 3.1 |
| Plasma 2 | 54.1 | 10.1 | 17.8 | 4.3 | 11.5 | 2.2 |

While the best mode for carrying out the invention has been described in detail, those familiar with the art to which this invention relates will recognize various alternative designs and embodiments for practicing the invention as defined by the following claims. For instance, the substrate that the adhesive is attached to may be non-polymeric such as metallic.

1. A method for adhesively securing a part to a polymeric substrate, the method comprising:
providing an adhesive layer having a bonding surface having a first oxygen composition;
providing a part having a bondable surface;
providing a polymeric substrate having a mating surface;
directing spray from an air plasma device onto at least a portion of the bonding surface of the adhesive to provide a second oxygen composition on the bonding surface of the adhesive layer, the second oxygen composition being greater than the first oxygen composition; and securing the adhesive layer between the bondable surface of the part and the mating surface of the polymeric substrate.

2. The method of claim 1, wherein the adhesive layer is located on the bondable surface of the part prior to providing the second oxygen composition on the bonding surface of the adhesive layer.

3. The method of claim 2, wherein the step of securing the adhesive layer between the bondable surface of the part and the mating surface of the polymeric substrate comprises applying pressure to secure the adhesive layer to the polymeric substrate.

4. The method of claim 1, wherein the adhesive layer is secured to the bondable surface of the part after providing the second oxygen composition on the bonding surface of the adhesive layer.

5. The method of claim 1, wherein the second oxygen composition is 1-50 atomic percent greater, as measured by X-ray photoelectron spectroscopy, than the first oxygen composition.

6-10. (canceled)

11. The method of claim 1, wherein the adhesive layer includes an upper layer comprising the top most atomic layer of the adhesive layer and a lower layer comprising the remainder of the adhesive layer, wherein after the spray has been directed onto the adhesive layer, the upper layer of the adhesive layer substantially having the second oxygen composition.

12-13. (canceled)

14. The method of claim 1, wherein the first oxygen composition is less than 20 atomic percent and the second oxygen composition is greater than 21 atomic percent, as measured by x-ray photoelectron spectroscopy.

15. The method of claim 4, wherein the part is polymeric and the method further comprises directing spray from an air plasma device onto the bondable surface of the polymeric part and disposing the adhesive layer on the bondable surface of the polymeric part, the bondable surface having a third oxygen composition prior to directing spray from an air plasma device onto the bondable surface and a fourth oxygen composition after directing spray from an air plasma device onto the bondable surface, the third oxygen composition being less than 20 atomic percent and the fourth oxygen composition being at least 22 atomic percent, as measured by X-ray photoelectron spectroscopy.

16-17. (canceled)

18. A method for securing a polymeric part to a polymeric substrate, the method comprising:
providing a polymeric part having an adhesive layer having a first oxygen composition;
providing a polymeric substrate having a mating surface;
oxidizing the adhesive layer by directing spray from an air plasma device onto the adhesive layer to provide the adhesive layer with a second oxygen composition, the second oxygen composition being 5-30 atomic percent greater, as measured by X-ray photoelectron spectroscopy, than the first oxygen composition; and
cohesively securing the adhesive layer to the mating surface of the polymeric substrate.

19. (canceled)

20. A polymeric part assembly for attachment to a polymeric body, comprising:
a polymeric part having a bondable surface; and
a single adhesive layer having a first side attached to the bondable surface of the polymeric part and an oxidized second side for attachment to the polymeric body;
wherein the oxidized second side of the adhesive layer has an oxidized oxygen composition 5-30 atomic percent greater, as measured by X-ray photoelectron spectroscopy, than a non-oxidized oxygen composition of a portion of the adhesive layer separate from the oxidized second side.

21. The polymeric part assembly of claim 20, wherein the oxidized oxygen composition is at least 21 atomic percent.

22. The polymeric part assembly of claim 20, wherein the oxidized oxygen composition is 23 to 50 atomic percent.

23. The polymeric part assembly of claim 20, wherein the oxidized oxygen composition is 24 to 40 atomic percent.

24. The polymeric part assembly of claim 20, wherein the oxidized oxygen composition is 25 to 32 atomic percent.

25. The polymeric part assembly of claim 20, wherein at least a portion of the bondable surface of the polymeric part is oxidized to form an oxidized bondable surface.

26. The polymeric part assembly of claim 25, wherein the oxidized bondable surface of the polymeric part has an oxygen composition of 23 to 50 atomic percent.

27. The polymeric part assembly of claim 20, wherein the oxidized second side of the single adhesive layer is attached to an oxidized mating surface of the polymeric body.

28. The polymeric part assembly of claim 27, wherein the oxidized mating surface of the polymeric body has an oxygen composition of 23 to 50 atomic percent.

29. The polymeric part assembly of claim 20, the oxidized second side containing the top most atomic layer of the adhesive layer, the first side and the oxidized second side together defining a bulk in between, wherein the first side, the oxidized second side, and the bulk integrally form the single adhesive layer of a single polymer composition.

30. The polymeric part assembly of claim 20, wherein one or more leading edges of the single adhesive layer are selectively oxidized to form the oxidized second side.
